(19) United States
(12) Patent Application Publication
(10) Pub. No.: US 2018/0339788 A1
(43) Pub. Date: Nov. 29, 2018

(54) PROTECTIVE CAP AND NUT GAUGE FOR AN AIRCRAFT FUEL TANK FASTENER SYSTEM

(71) Applicant: Joe A. Garcia, Santa Fe Springs, CA (US)

(72) Inventor: Joe A. Garcia, Santa Fe Springs, CA (US)

(21) Appl. No.: 15/606,538

(22) Filed: May 26, 2017

(51) Int. Cl. B64D 37/32; B64D 45/02; H05F 3/02

(52) U.S. Cl. CPC B64D 37/32; B29L 2031/3085; H05F 3/02; B64D 45/02

(57) ABSTRACT

Disclosed is an electrically non-conductive (e.g., dielectric) protective cap to enclose the threaded shank of a metallic bolt that connects a fuel tank to the wing of an aircraft. The protective cap has a threaded bolt retaining cavity within which to receive the threaded shank of the fastener after the threaded shank has been pushed through a bolt hole formed in a side of the fuel tank. The protective cap is rotated into mating engagement with the threaded shank of the fastener inside the fuel tank so as to completely surround and protect the shank against a lightning strike during flight. By counting the number of rotations of the protective cap into its mating engagement with the threaded shank of the fastener, an indication is provided of the number of threads of the threaded shank that are located inside the fuel tank.

### BACKGROUND OF THE INVENTION

### 1. Field of the Invention

This invention relates to a threaded, electrically non-conductive protective cap that is rotated into surrounding mating engagement with the threaded shank of a bolt from a fastener system that connects a fuel tank to the wing of an aircraft. The protective cap completely encloses the threaded shank of the bolt which extends into the fuel tank so as to prevent the shank from being struck by lightning during flight. The protective cap also functions as a gauge to indicate whether a locking nut has been reliably coupled to the threaded shank of the bolt to secure the fuel tank to the wing.

### 2. Background Art

A fuel tank is carried within the wing of many aircraft to provide the aircraft with a source of fuel. The fuel tank must be fixedly connected to the wing within which it is located. This connection is typically accomplished by a fastener system consisting of many threaded nut and threaded bolt combinations. In this case, the threaded bolts extend through the structure of the wing and into the fuel tank at which to be engaged by the threaded nuts. To prevent the bolts from being struck by lightning inside the fuel tank, the bolts are commonly covered by a protective end cap.

To hold the end cap in place, a polysulfide sealant is often applied over the bolt and nut combinations. The end caps are then positioned over each of the bolt and nut combinations while pressure is applied to the cap so as to allow time for the sealant to set. It is known to take over 60 seconds before the sealant will set in order to be able to seal each end cap to each bolt and nut pair. When a large number of bolt and nut pairs are used to connect the fuel tank to the wing, a considerable amount of installation time may be expended before all of the end caps can be sealed over the entire fastener system. Moreover, there is no way to accurately detect if any threaded bolt or threaded nut has been improperly installed once the sealant has been applied thereover. Accordingly, it would be desirable to improve the efficiency and reduce the installation time required to hold a large number of protective caps over and around a large number of bolt and nut combinations from a fuel tank fastener system by eliminating the conventional polysulfide or similar sealant that has been heretofore used to hold the caps in place.

### SUMMARY OF THE INVENTION

Disclosed herein is a protective cap to be mated to a threaded shank of a metallic bolt that is used to connect a fuel tank to the wing of an aircraft. The bolt is received through a rib of the wing and an adjacent side of the fuel tank so that the threaded shank of the bolt is located inside the fuel tank. The protective cap is manufactured from an electrically non-conducting dielectric material (e.g., nylon CX7323). The protective cap includes an axially aligned bore located at one end thereof, a threaded bolt retaining cavity located at the opposite end, and an intermediate counter bore. Once the bolt is installed through the rib and into the fuel tank, a threaded locking nut is connected to the threaded shank of the bolt to lock the bolt in place. The protective cap is then rotated into surrounding engagement with the threaded shank of the bolt such that the threaded shank is received within and mated to the threaded bolt retaining cavity of the cap. The non-conducting protective cap completely covers and encloses the threaded shank of the bolt and the locking nut attached to the shank to prevent the shank from being struck by lightning within the fuel tank.

The protective cap disclosed herein also functions as a gauge to provide an indication whether the bolt has been completely installed so that the threaded shank thereof protrudes fully within the fuel tank by which to enable the threaded locking nut to be reliably connected to the threaded shank. That is, depending upon the number of turns required to rotate the protective cap into its surrounding engagement with the threaded shank of the bolt, an indication is given as to the number of threads of the threaded shank that are located inwardly of the fuel tank to enable a workman to verify that a sufficient number of threads from the threaded shank are available to permit a reliable connection thereto of the locking nut.

### BRIEF DESCRIPTION OF THE DRAWINGS

FIG. 1 shows the wing of an aircraft and a fuel tank secured to the wing by a fastener system which includes a number of threaded bolts;

FIG. 2 is an exploded view showing the shank of one of the threaded bolts from the fastener system of FIG. 1 passing through a rib of the wing and an adjacent side of the fuel tank so as to be located inside the fuel tank at which to be mated to a protective non-conductive cap in accordance with the improvement described herein;

FIG. 3 shows a pair of protective caps surrounding and enclosing the shanks of respective threaded bolts once the bolts have been installed through the side of the fuel tank;

FIG. 4 is an exploded partial cross-section taken along lines 4-4 of FIG. 2 showing the protective cap aligned to be moved into mating engagement with the shank of the threaded bolt shown in FIG. 2; and

FIG. 5 is a partial cross-section showing the protective cap after being moved into mating engagement with the shank of the threaded bolt by which to connect the fuel tank to the wing of the aircraft.

### DESCRIPTION OF THE PREFERRED EMBODIMENT

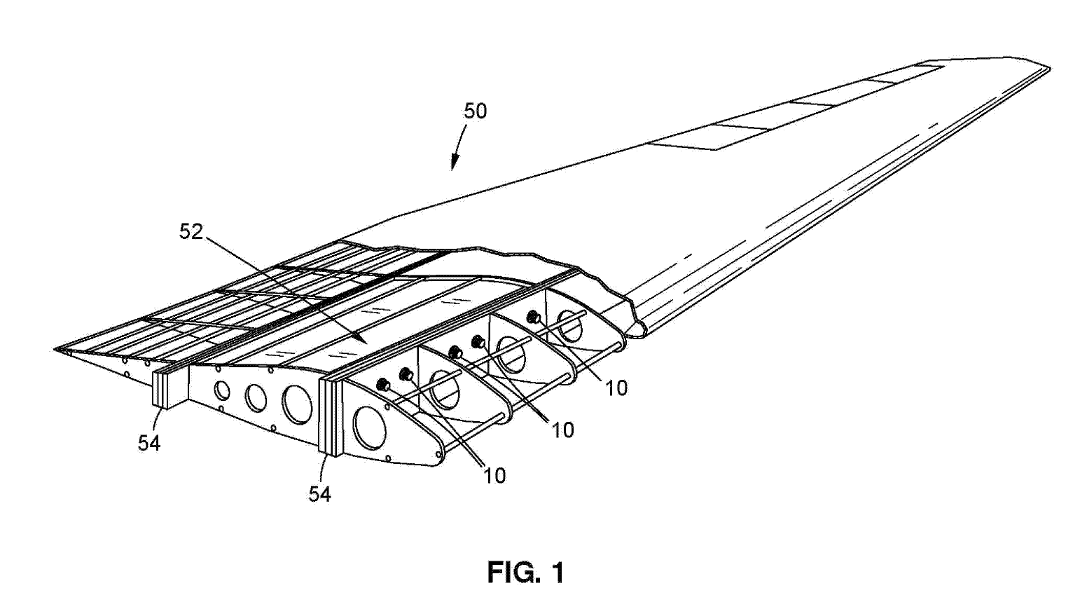

Referring initially to FIG. 1 of the drawings, there is shown a wing 50 that is part of a conventional (e.g., jet) aircraft. The wing 50 carries a standard fuel tank 52 at the interior thereof within which to store a supply of fuel to be used to propel the aircraft. The fuel tank 52 is securely connected to the wing 50 between structural ribs 54 that run longitudinally along the wing across opposite sides of the fuel tank. The foregoing connection is accomplished by means of a fastener system that includes a large number of fasteners which extend between the ribs 54 and the fuel tank 52. A fastener from the fastener system that is commonly used to connect the fuel tank 52 to each one of the opposing ribs 54 of the wing 50 is a threaded metallic bolt 10. As shown in FIG. 1, each threaded bolt 10 penetrates a rib 54 of the wing 50 to be received inwardly of the fuel tank 52 through one side thereof.

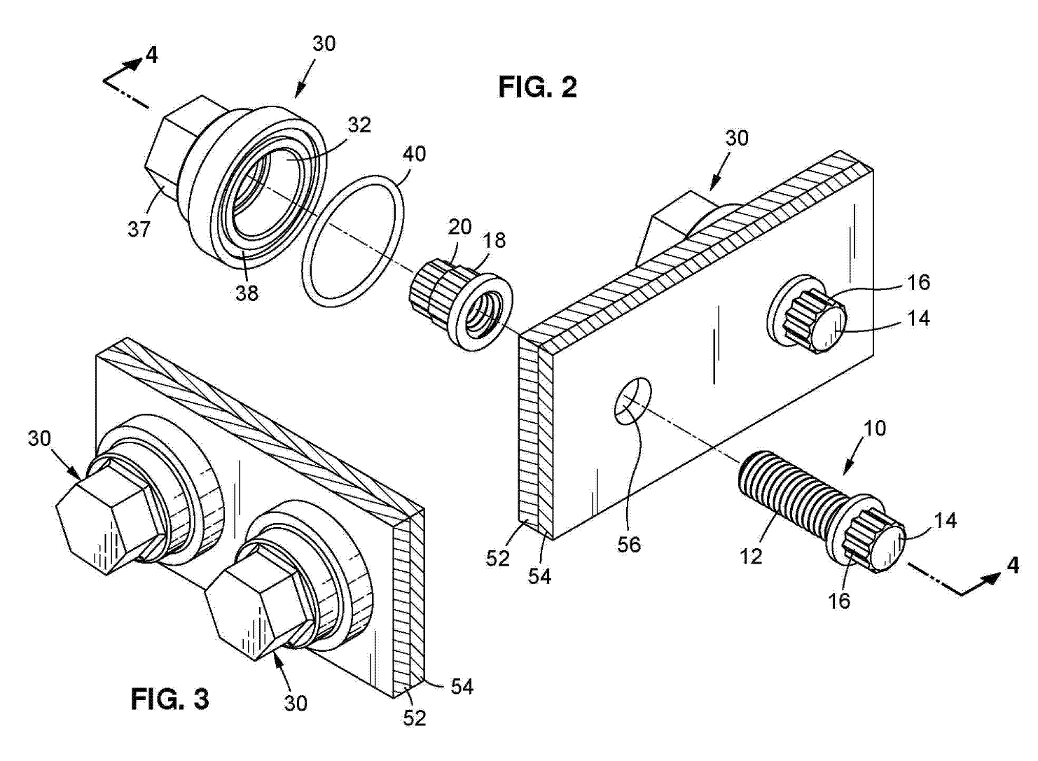

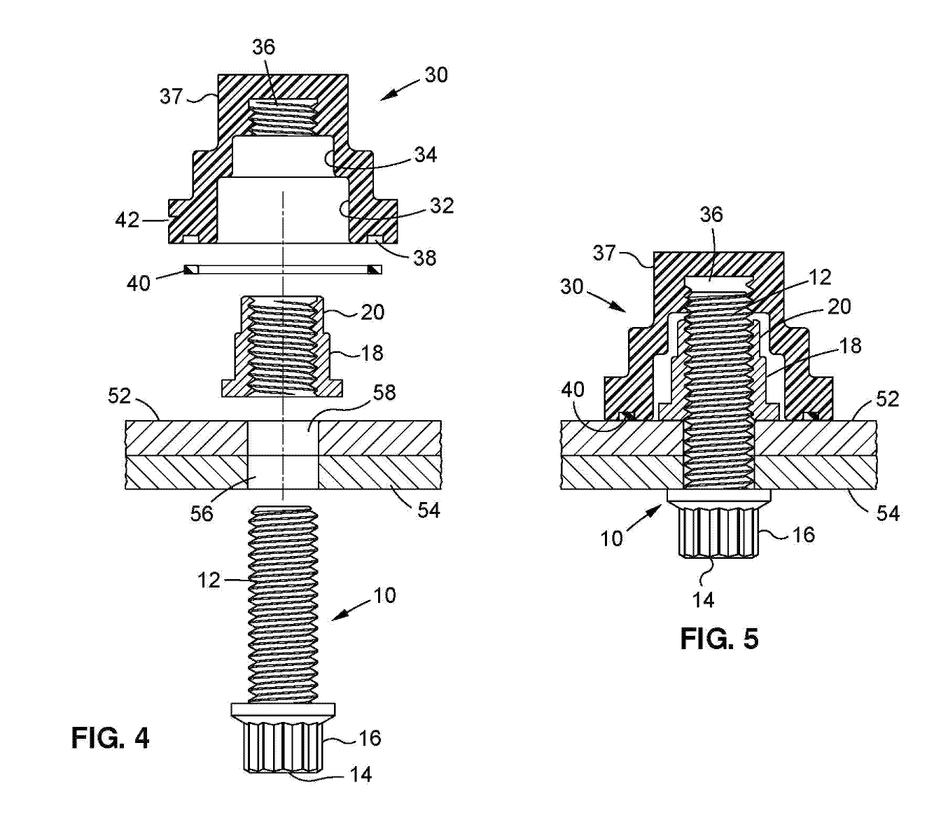

Referring currently now to FIGS. 2-5 of the drawings, the aforementioned threaded bolt 10 is shown in detail. The bolt 10 has an elongated threaded body (i.e., shank) 12 at one end thereof and an enlarged head 14 at the opposite end. The head 14 of bolt 10 is provided with a wrenching surface 14. A suitable tool (not shown) is used to engage the wrenching surface 14 so as to apply a rotational force to the head 14 for rotating the bolt 10 through a pair of axially aligned bolt holes 56 and 58 (best shown in FIG. 4) that are formed through one side of the fuel tank 52 and an adjacent rib 54 which lies flush against the fuel tank. When the bolt 10 is installed through the axially aligned bolt holes 56 and 58 during assembly of the wing, the threaded shank 12 of bolt 10 will extend inside of the fuel tank 52, and the enlarged head 14 of the bolt 10 will lie outside the fuel tank and against the rib 54 at which to receive the aforementioned rotational force applied to the wrenching surface 16 thereof.

Once the threaded bolt 10 has been installed through the side of the fuel tank 52 and the adjacent rib 54 via bolt holes 58 and 56, a threaded cylindrical locking nut 18 is rotated into surrounding engagement with the threaded shank 12 to lie flush against the fuel tank 52 in order to lock the bolt in place and secure the fuel tank 52 to the rib 54. As is best shown in FIG. 5, once the bolt 10 and nut 18 have been installed, the threaded shank 12 of bolt 10 passes through the nut 18 and into the fuel tank. As is best shown in FIG. 4, a relatively narrow threaded cylindrical locking barrel 20 extends outwardly from the bottom of the locking nut 18 to be simultaneously rotated into mating engagement with the threaded shank 12 at the same time as the locking nut 18.

Because the elongated threaded shank 12 of the metallic bolt 10 is exposed within the fuel tank 52 of the wing of the aircraft, it is desirable to protect the shank from lightning strikes to which the wing is susceptible during flight. To overcome this problem, and in accordance with the improvement herein disclosed, a protective cap 30 is employed to completely enclose and isolate the shank 12 of bolt 10 lying within the fuel tank 52. The protective cap 30 is preferably molded from an optically clear (i.e., transparent) and electrically non-conductive dielectric material. By way of example only, one suitable clear non-conductive material from which the protective cap 30 can be manufactured is TROGAMID® nylon CX7323 or the like.

As is best shown in FIG. 4, the non-conductive protective cap 30 includes a bore 32 located at a first end thereof within which to receive the threaded shank 12 of bolt 10. Axially aligned and communicating with the bore 32 is a relatively narrow counterbore 34. The counterbore 34 of cap 30 is sized so that in the assembled fastener and protective cap configuration shown in FIG. 5, the locking barrel 20 which extends from the bottom of the threaded locking nut 18 and embraces the threaded shank 12 of the bolt 10 is received within counterbore 34.

Recessed within the opposite end of the protective cap 30 so as to be axially aligned and communicate with the bore 32 and the counterbore 34 is a bolt retaining cavity 36. A series of threads are molded into the cavity 36 to match the threads of the shank 12 of bolt 10. After the threaded bolt 10 and nut 18 have been installed as described above, the protective cap 30 is rotated at a hexagonal wrenching surface 37 thereof towards and into surrounding engagement with the bolt 10. Accordingly, the threaded shank 12 of bolt 10 is drawn through the bore 32 and the counterbore 34 and reliably connected to the threaded bolt retaining cavity 36 of cap 30 (best shown in FIG. 5). By virtue of the protective cap 30 and the threaded shank 12 of bolt 10 being mated to one another by means of their respective threaded surfaces, the conventional application of an inconvenient and time consuming sealant to lock an end cap to the threaded end of a bolt can be advantageously avoided.

As is best shown in FIG. 3, once all of the protective caps 30 are moved into surrounding engagement with respective ones of the bolts 10 of the fastener system that extend into the fuel tank 52 of the aircraft, the threaded shank 12 of each bolt and the threaded nut 18 coupled thereto will be completely covered by a non-conductive enclosure to prevent their being struck by lightning.

The protective cap 30 herein disclosed advantageously and simultaneously performs another useful function in addition to preventing the threaded bolt 10 from being struck by lightning. More particularly, the protective cap 30 also functions as a gauge to provide an indication whether the bolt 10 has been properly installed so as to protrude by at least a minimum length through the rib 54 of the aircraft wing 50 and into the fuel tank 52 so that a sufficient number of threads will be available within the fuel tank to enable both the threaded locking nut 18 and the threaded cap 30 to be reliably connected to the threaded shank 12 of bolt 10 in order to hold the bolt 10 in place and thereby connect the fuel tank 52 to its adjacent rib 54.

That is, the workman who applies a rotational force to the wrenching surface 37 of the protective cap 30 can count the number of rotations made by the cap as it is rotated into its mating engagement with the threaded shank 12 of bolt 10. To facilitate the count, a marking 42, such as a notch or a line, is inscribed into the protective cap 30 outside the bore 32 thereof (best shown in FIG. 4) to be observed by the workman. Should the cap 30 undergo a number of rotations that is less than a predetermined number which is indicative of the bolt 10 being inserted by less than a corresponding minimum distance through the axially aligned openings 56 and 58 (of FIG. 4) so that less than a minimum required number of threads of the threaded shank 12 are accessible inside the fuel tank 52 to be engaged by the protective cap 30, the workman will be alerted to the possibility that either the bolt 10 or the threaded locking nut 18 has not been properly installed as would be required to couple each of the nut 18 and the cap 30 to the bolt 10 and produce a reliable connection therebetween. What is more, when the protective cap 30 is manufactured from an optically clear dielectric material in accordance with the example described above, the workman can visually inspect the threads of the bolt 10 and the locking nut 18 connected thereto.

To create a fluid-tight seal of the protective cap 30 at the inside of the fuel tank 52 against which the cap 30 is tightened, a peripheral channel 38 is formed around the cap 30 so as to surround the bore 32 thereof. An annular, non-conductive and elastomeric washer 40 is pushed into the channel 38. When the protective cap 30 is rotated at its wrenching surface 37 into mating engagement with the threaded shank 12 of bolt 10, the washer 40 is pressed into contact with and compressed against the fuel tank 52 to create the fluid-tight seal. Rather than locate the elastomeric washer 40 in the channel 38, the channel 38 can be eliminated and the washer 40 can simply be located and compressed between the protective cap 30 and the opposing side of the fuel tank 52.

1. A fastener system to secure a fuel tank to a structural support of an aircraft, said fastener system comprising:
a fastener having a head at one end thereof and a threaded body at the opposite end, said threaded body extending through the structural support of the aircraft and a side of the fuel tank to be located inside the fuel tank; and
a protective cap having a threaded cavity formed therein within which to receive and at which to be connected to the threaded body of said fastener when said threaded body is located inside the fuel tank, the threaded cavity of said protective cap being rotated with said protective cap into mating engagement with the threaded body of said fastener so that said threaded body is surrounded by said protective cap.

2. The fastener system recited in claim 1, wherein said protective cap is manufactured from an electrically non-conductive material.

3. The fastener system recited in claim 2, wherein said electrically non-conductive material is optically transparent.

4. The fastener system recited in claim 1, further comprising a threaded locking nut rotated into mating engagement with the threaded body of said fastener at the inside of the fuel tank to connect said fastener to the fuel tank, said threaded body extending through said threaded locking nut to be received within and mated to the threaded cavity of said protective cap.

5. The fastener system recited in claim 4, wherein said protective cap lies flush against the side of the fuel tank through which the threaded body of said fastener extends so as to surround said threaded body and said threaded locking nut that is mated to said threaded body when said protective cap is rotated into said mating engagement with said threaded body.

6. The fastener system recited in claim 5, wherein said protective cap has first and opposite ends, a round bore being located at the first end thereof through which the threaded body of said fastener is moved, and the threaded cavity of said protective cap being located at the opposite end thereof within which to receive said threaded body, said threaded locking nut surrounding said threaded body and being located within the bore of said protective cap when said protective cap is rotated into said mating engagement with said threaded body.

7. The fastener system recited in claim 6, wherein said protective cap also has a round counterbore located between the round bore and the threaded cavity thereof, said round counterbore having a diameter which is smaller than the diameter of said round bore, and said threaded locking nut having a threaded locking barrel extending therefrom so as to be rotated into surrounding engagement with the threaded body of said fastener and located within the counterbore of said protective cap.

8. The fastener recited in claim 6, wherein the opposite end of said protective cap has a hexagonal wrenching surface extending therearound to which a rotational force is applied to cause said protective cap to be rotated into said mating engagement with the threaded body of said fastener.

9. The fastener system recited in claim 6, wherein the first end of said protective cap has a channel recessed therein, said fastener system further comprising an elastomeric washer located within said channel and laying flush against the side of said fuel tank to form a seal when said protective cap is rotated into said mating engagement with the threaded body of said fastener and said protective cap lays flush against the side of the fuel tank.

10. A method for indicating whether the threaded body of said fastener recited in claim 4 extends at least a minimum distance inside the fuel tank to enable said threaded locking nut to be rotated into said mating engagement with the threaded body of said fastener, said method comprising the steps of counting the number of rotations of said protective cap at the inside of the fuel tank until said protective cap has been rotated into said mating engagement with said threaded body; and correlating the number of rotations counted with a corresponding number of threads of said threaded body that are received by the threaded cavity of said protective cap.

11. The method recited in claim 10, including the additional step of applying a marking to said protective cap to provide a visual indication of the number of rotations of said protective cap into said mating engagement with the threaded body of said fastener.
